(19) United States
(12) Patent Application Publication
(10) Pub. No.: US 2020/0052489 A1
(43) Pub. Date: Feb. 13, 2020

(54) MOTOR DRIVE SYSTEM INCLUDING POWER STORAGE DEVICE

(71) Applicant: FANUC CORPORATION, Yamanashi (JP)

(72) Inventors: Shougo SHINODA, Yamanashi (JP); Satoshi IKAI, Yamanashi (JP)

(21) Appl. No.: 16/513,708

(22) Filed: Jul. 17, 2019

(30) Foreign Application Priority Data
Aug. 13, 2018 (JP) 2018-152362

(51) Int. Cl. H02J 3/30; H02M 7/48; H02J 3/32; H02J 1/16; H02P 3/18

(52) U.S. Cl. CPC H02J 3/30; H02M 7/4826; H02P 3/18; H02J 1/16; H02J 3/32

(57) ABSTRACT

A motor drive system includes a power source unit configured to supply DC power to a DC link, a servo-amplifier for drive configured to convert the DC power in the DC link into AC power and supply the AC power as drive power to a servomotor for drive, a power storage device configured to store the DC power from the DC link or supply the DC power to the DC link, a power consumption calculation unit configured to calculate total power consumption as the sum of power consumed by the servomotor for drive, the servo-amplifier for drive and the power source unit, and a power storage device control unit configured to control power storage and power supply of the power storage device according to the total power consumption, wherein the power storage device control unit determines start and end of power storage or power supply, based on different thresholds.

### BACKGROUND OF THE INVENTION

### 1. Field of the Invention

The present invention relates to a motor drive system including a power storage device.

### 2. Description of the Related Art

In a motor drive system for driving a servomotor provided to machines including a machine tool, a robot etc., (hereinafter, referred to as “servomotor for drive”), AC power supplied from an AC power source is converted into DC power by a converter, the DC power is output to a DC link, the DC power in the DC link is further converted into AC power by an inverter, and the AC power is used as drive power for the servomotor for drive. The “DC link” indicates a circuit part that electrically connects the DC output side of the converter and the DC input side of the inverter, which may also be referred to as a “direct current link unit,” a “DC link unit,” or a “DC link circuit.” It is a common practice to provide one converter for a plurality of inverters to reduce the cost and the footprint of the motor drive system. In other words, a converter configured to convert AC power supplied from an AC power source into DC power is used as a common power source unit, and a plurality of servo-amplifiers for drive (inverters) use the DC power that is output from the power source unit to generate AC power for driving each servomotor for drive.

In acceleration or deceleration control of the servomotor for drive by the motor drive system, a power peak occurs because the AC power source is requested to output or regenerate high AC power. Especially in a motor drive system including a plurality of servo-amplifiers for drive (inverters), which are connected to one power source unit (converter), the occurring power peak may be relatively high. Reducing the power peak because the higher the power peak is desirable, since the higher the power source capacity and the operational cost of the motor drive system, and the more power problems such as power failure and flickering are likely to occur in the power source.

To reduce the power peaks, in one conventionally used method, a power storage device which can store DC power in a DC link that connects the power source unit to the servo-amplifier for drive in the motor drive system is provided, and energy consumed or regenerated by the servomotor for drive is exchanged as appropriate via the DC link. With this method, the power peaks can be reduced because, during deceleration of the servomotor for drive, regenerative power generated from the servomotor for drive can be stored in the power storage device, and the stored power can be reused during acceleration of the servomotor for drive. In other words, the use of a power storage device which inputs and outputs power to and from the DC link allows even operation of the servomotor for drive which involves power consumption higher than the maximum power supply of the power source unit (e.g., acceleration and deceleration). Examples of the power storage device include a flywheel power storage device and a capacitor power storage device.

As an example, a press machine causes a very high maximum power consumption during a press operation and often poses a problem related to capacity shortage of a power source unit. To solve this problem, a motor drive system in a press machine includes a flywheel power storage device provided in a DC link and the power storage device supplies power when the press machine consumes high power, which allows driving of the press machine connected to even a small-capacity power source unit. For example, when the servomotor for drive consumes low power, a servomotor for buffer coupled to a flywheel is rotated at a constant speed, and when the servomotor for drive consumes higher power due to, e.g., its acceleration or deceleration, the rotational speed of the servomotor for buffer is lowered, power regeneration is performed via an inverter for buffer, and DC power for driving the servomotor for drive is supplied to the DC link. Hence, even for an acceleration and deceleration operation of servo-amplifier for drive which consumes power higher than the maximum output power of the power source unit, driving can be performed using regenerative power from the servomotor for buffer coupled to the flywheel having rotation energy.

As disclosed in, e.g., Japanese Unexamined Patent Publication No. 2013-009524, a motor drive device is known to include an AC/DC converter which converts AC power from an AC power source into DC power, a DC/AC converter which converts DC power into AC power for driving a motor or converts AC power regenerated from the motor into DC power, a DC link unit which connects a DC side of the AC/DC converter to a DC side of the DC/AC converter and transfers DC power, an energy storage unit including at least one capacitor storage unit and at least one flywheel storage unit, which is connected to the DC link unit and stores the DC power from the DC link unit or supplies the DC power to the DC link unit, a motor control unit which performs control to allow the DC/AC converter to output desired AC power, in accordance with a motor operation command related to an operation of the motor, and an energy control unit which controls the energy storage unit to store the DC power from the DC link unit or supply the DC power to the DC link unit.

As disclosed in, e.g., Japanese Unexamined Patent Publication No. 2016-046833, a system for controlling a servomotor for driving an axis of industrial machinery or a machine tool is known to include a plurality of first servomotors for driving axes, a plurality of converters which convert AC voltage into DC voltage, a plurality of first inverters which receive the DC voltage from the converters and convert the DC voltage into AC voltage for driving the plurality of first servomotors or convert AC power regenerated from the first servomotors into DC power, second servomotors which rotate inertia, a plurality of second inverters which receive the DC voltage from the converters and convert the DC voltage into AC voltage for driving the second servomotors or convert AC power regenerated from the second servomotors into DC power, and a servomotor controller which controls the plurality of first servomotors and the second servomotors, wherein the second servomotors are fewer in number than the plurality of second inverters, at least one of the second servomotors includes a plurality of independent windings, and at least some of the plurality of second inverters are connected to a plurality of independent windings provided in one second servomotor.

### SUMMARY OF INVENTION

In a motor drive system including a power storage device for reducing power peaks of power source equipment, for example, the power storage device starts/ends storing power and starts/ends supplying power according to increase/decrease of “total power consumption” as the sum of power consumed by the servomotor for drive, the servo-amplifier for drive and the power source unit. When, for some reason, oscillation that is different from oscillation caused by operation attributable to actual control occurs on a drive axis that is connected to the servomotor for drive, the oscillation is transmitted to the rotation shaft of the servomotor for drive, and as the result, the output of the servomotor for drive becomes oscillational. In an example of a press machine, when a pressuring unit becomes in contact with a work in a pressing process, stress acts on the pressuring unit, generating oscillation in a servomotor for drive that is connected to the pressuring unit. In general, winding loss of the servomotor for drive, loss of the power source unit and loss of the servo-amplifier for drive are smaller than the absolute value of the output of the servomotor for drive, thus, the output of the servomotor for drive has a dominant influence on the total power consumption. Therefore, the oscillation of the output of the servomotor for drive generally corresponds to the oscillation of the total power consumption. When the total power consumption oscillates, the power storage device frequently starts and ends storing power and starts and ends supplying power. For example, when the power storage device is a flywheel power storage device, a servomotor for buffer coupled to a flywheel frequently performs unnecessary acceleration and deceleration, causing heavy burden on the servomotor for buffer, making it susceptible to failure and shortening life. When the power storage device is a capacitor power storage device, for example, an oscillating voltage fluctuation occurs in a capacitor, causing heavy burden on the capacitor, making it susceptible to failure and shortening life. Therefore, for a motor drive system including a power storage device for reducing power peaks of power source equipment, a technique for avoiding failure and extending the life of the power storage device is desired.

According to one aspect of the present disclosure, a motor drive system includes: a power source unit configured to supply DC power to a DC link; a servo-amplifier for drive configured to convert the DC power in the DC link into AC power and supply the AC power as drive power to a servomotor for drive; a power storage device configured to store the DC power from the DC link or supply DC power to the DC link; a power consumption calculation unit configured to calculate total power consumption as the sum of power consumed by the servomotor for drive, the servo-amplifier for drive and the power source unit; and a power storage device control unit configured to control power storage and power supply of the power storage device according to the total power consumption, in which the power storage device control unit determines start and end of power storage or power supply of the power storage device, based on different thresholds.

### BRIEF DESCRIPTION OF THE DRAWINGS

The present invention will be understood more clearly by referring to the following accompanying drawings:

FIG. 1 is a block diagram illustrating a motor drive system according to an embodiment of the present disclosure;

FIG. 2 is a block diagram illustrating the motor drive system according to an embodiment, which includes a flywheel power storage device;

FIG. 3 is a block diagram illustrating the motor drive system according to an embodiment, which includes a capacitor power storage device;

FIG. 4 is a graph illustrating an exemplary relationship between DC power supplied from the power storage device in the motor drive system to a DC link and DC power supplied from a power source unit to the DC link, according to an embodiment of the disclosure;

FIG. 5 is a flowchart illustrating the operation sequence of the motor drive system according to an embodiment of the present disclosure;

FIG. 6 is a timing chart illustrating an exemplary relationship between the total power consumption and a speed command that is output by the power storage device control unit in the motor drive system that includes a flywheel power storage device according to an embodiment of the disclosure;

FIG. 7 is a timing chart illustrating an exemplary relationship between the total power consumption and a voltage command that is output by the power storage device control unit in the motor drive system that includes a capacitor power storage device according to an embodiment of the disclosure; and

FIG. 8 is a timing chart illustrating an exemplary relationship between the total power consumption and a speed command that is output by the power storage device control unit in a conventional motor drive system where power storage start and power storage end of the flywheel power storage device are detected with the same power storage threshold and power supply start and power supply end of the power storage device are detected with the same power supply threshold.

### DETAILED DESCRIPTION

A motor drive system including a power storage device will be described below with reference to the drawings. The same reference numerals denote the same members throughout these drawings. These drawings use different scales as appropriate to facilitate understanding. The mode illustrated in each drawing is one example for carrying out the present invention, and the present invention is not limited to the modes illustrated in these drawings. The “output of a servomotor for drive” includes the “power consumption of the servomotor for drive” and the “regenerative power of the servomotor for drive,” and the “output of a servomotor for buffer” includes the “power consumption of the servomotor for buffer” and the “regenerative power of the servomotor for buffer.” “Power consumption” is defined as positive, and “regenerative power” is defined as negative. The rotation angular speeds of the servomotor for drive and the servomotor for buffer are simply referred to as the “speed.” “Power value” means “the amount of work performed by current per unit time,” i.e., “work rate,” which is represented by the unit of “W (watt).” “Energy value” means “the amount of work performed by current,” i.e., “power amount,” which is represented by the unit of “J (joule).” Accordingly, a relationship of “energy value [J]=power value [W]×time [s]” can be established.

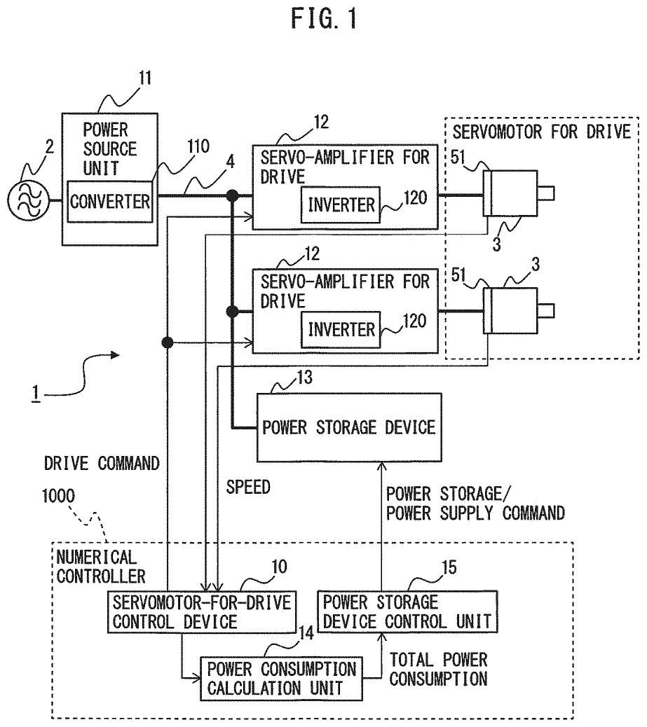

FIG. 1 is a block diagram illustrating a motor drive system according to an embodiment of the present disclosure. A case where a motor drive system 1 controls two servomotors for drive 3 will be described as an example. The number of servomotors for drive 3 does not particularly limit this embodiment and may be one, or three or more. The numbers of phases of the AC power source 2 and the servomotors for drive 3 do not particularly limit this embodiment and, for example, a three-phase or single-phase AC configuration may be used. Furthermore, the types of the servomotors for drive 3 do not particularly limit this embodiment, and induction or synchronous motors, for example, may be used. Machines equipped with the servomotors for drive 3 include, e.g., a machine tool, a robot, forging machinery, an injection molding machine, industrial machinery, various electrical appliances, an electric train, an automobile, and aircraft. Examples of the AC power source 2 include a three-phase AC 400 V power source, a three-phase AC 200 V power source, a three-phase AC 600 V power source, and a single-phase AC 100 V power source.

First, the circuit components of the motor drive system 1 will be described.

As illustrated in FIG. 1, the motor drive system 1 according to the embodiment includes a power source unit 11, servo-amplifiers for drive 12, a power storage device 13, a power consumption calculation unit 14, and a power storage device control unit 15. The motor drive system 1 further includes a servomotor-for-drive control device 10. In the embodiment of the drawings, as an example, the power consumption calculation unit 14, the power storage device control unit 15, and the servomotor-for-drive control device 10 are provided in a numerical controller 1000 of a machine tool. Note that the power consumption calculation unit 14, the power storage device control unit 15, and the servomotor-for-drive control device 10 may be provided in a processor other than the numerical controller 1000.

The power source unit 11 supplies DC power to the DC link 4. In the illustrated embodiment, for example, the power source unit 11 is configured by a converter 110 that converts AC power supplied from the AC power source 2 into DC power and outputs the DC power to the DC link 4. The converter 110 is implemented as a three-phase bridge circuit when a three-phase alternating current is supplied from the AC power source 2, and as a single-phase bridge circuit when a single-phase alternating current is supplied from the AC power source 2. Examples of the converter 110 include a diode rectifier circuit, a 120-degree conduction rectifier circuit and a PWM switching control rectifier circuit. When the converter 110 is implemented as, e.g., a diode rectifier circuit, it rectifies AC current supplied from the AC power source 2 and outputs DC current to the DC link 4. When the converter 110 is implemented as, e.g., a PWM switching control rectifier circuit, it is implemented as a bridge circuit of switching elements and diodes connected in antiparallel with the switching elements and performs bidirectional AC/DC power conversion by ON/OFF control of each switching element in accordance with a drive command received from, for example, the numerical controller 1000. Examples of the switching element may include a unipolar transistor such as a field effect transistor (FET), a bipolar transistor, an insulated gate bipolar transistor (IGBT), a thyristor, and a gate turn-off thyristor (GTO). However, the type of switching element itself does not limit this embodiment, and other types of switching element may be used.

For the converter 110 in the power source unit 11, “maximum power supply” is defined as maximum power up to which AC power can be converted into DC power and supplied to the DC link 4. The maximum power supply is generally defined as specification data associated with the conversion capacity of the converter 110 and is specified in, e.g., a specification table or an instruction manual of the converter 110. Note that, when the converter 110 in the power source unit 11 is configured by a device that allows bidirectional AC/DC power conversion, such as a PWM switching control rectifier circuit, “maximum regenerative power” is defined as maximum power up to which DC power in the DC link 4 can be converted into AC power and regenerated to the AC power source 2 side. The maximum regenerative power is generally defined as specification data about conversion capacity of the converter 110 that allows bidirectional AC/DC power conversion and is specified in, e.g., a specification table or an instruction manual of the converter 110. Hereinafter, the maximum power supply and maximum regenerative power of the converter 110 may be collectively referred to as the “maximum conversion power.”

Note that the power source unit 11 may be implemented as, e.g., a primary battery, a secondary battery, or a solar battery.

As illustrated in FIG. 1, when the power source unit 11 is implemented as the converter 110, the DC link 4 in general includes a DC link capacitor (also referred to as a smoothing capacitor), though not illustrated in FIG. 1. The DC link capacitor has the functions of storing DC power in the DC link 4 and of suppressing ripples of the DC output of the converter 110 in the power source unit 11.

The power source unit 11 is connected to the servo-amplifiers for drive 12 through the DC link 4. The servo-amplifiers for drive 12 are configured to drive the servomotors for drive 3 using the DC power in the DC link 4. The servomotor for drive 3 generally includes at least one winding, and one servo-amplifier for drive 12 is required per winding in the servomotor for drive 3 to drive the servomotor for drive 3. FIG. 1 represents servomotors for drive 3 of the single-winding type as an example, and accordingly, one servo-amplifier for drive 12 is connected to each servomotor for drive 3.

The servo-amplifiers for drive 12 convert DC power of the DC link 4 into AC power and supply the AC power as drive power to the servomotors for drive 3. Thus, the servo-amplifier for drive 12 has, e.g., an inverter 120. The inverters 120 in the servo-amplifiers for drive 12 convert power between DC power of the DC link 4 and AC power serving as drive power or regenerative power for the servomotors for drive 3 by ON/OFF control of each switching element in accordance with a drive command received from the servomotor-for-drive control device 10. The inverter 120 is implemented as a bridge circuit of switching elements and diodes connected in antiparallel with the switching elements, and ON/OFF control of each switching element is performed based on PWM switching control of, e.g., a triangular wave comparison scheme. The inverter 120 is implemented as a three-phase bridge circuit when the servomotor for drive 3 serves as a three-phase motor and as a single-phase bridge circuit when the servomotor for drive 3 serves as a single-phase motor. Examples of the switching element may include a unipolar transistor such as an FET, a bipolar transistor, an IGBT, a thyristor, and a GTO, but the type of switching element itself does not limit this embodiment, and other types of switching element may be used.

The inverters 120 in the servo-amplifiers for drive 12 convert power between the DC power of the DC link 4 and AC power serving as drive power or regenerative power for the servomotors for drive 3 by ON/OFF control of each switching element in accordance with a drive command received from the servomotor-for-drive control device 10 (to be described later). More specifically, the inverters 120 perform the switching operation of the internal switching elements in accordance with a drive command received from the servomotor-for-drive control device 10 so as to convert DC power supplied from the power source unit 11 via the DC link 4 into AC power having desired voltage and a desired frequency for driving the servomotors for drive 3 (inversion operation). The servomotors for drive 3 thus operate basically with, e.g., variable-voltage, variable-frequency AC power. Regenerative power may be generated during deceleration of the servomotors for drive 3; in such a case, the switching operation of the internal switching elements is performed in accordance with a drive command received from the servomotor-for-drive control device 10 so as to convert the AC regenerative power generated in the servomotors for drive 3 into DC power and return the DC power to the DC link 4 (rectification operation).

The servomotor-for-drive control device 10 controls the servomotors for drive 3, each of which is connected to the servo-amplifier for drive 12, to operate (i.e., rotate) in accordance with a predetermined operation pattern. The operation pattern of the servomotors for drive 3 is formed by combining acceleration, deceleration, constant-speed rotation, and stop as appropriate in accordance with the operation details of the machine equipped with the servomotors for drive 3. The operation pattern of the servomotors for drive 3 is defined by an operation program for the servomotors for drive 3. When, for example, the servomotors for drive 3 are provided in a machine tool, an operation program for the servomotors for drive 3 is defined as one of machining programs for the machine tool.

Since the servomotors for drive 3 are controlled in speed, torque, or rotor position with, e.g., variable-voltage, variable-frequency AC power supplied from the inverters 120 in the servo-amplifiers for drive 12, control of the servomotors for drive 3 by the servomotor-for-drive control device 10 is eventually implemented by controlling the power conversion operation of the inverters 120 in the servo-amplifiers for drive 12. In other words, the servomotor-for-drive control device 10 controls the servomotors for drive 3 to operate in accordance with a predetermined operation program by controlling power conversion of the inverters 120 in the servo-amplifiers for drive 12. More specifically, the following operation is performed: The servomotor-for-drive control device 10 generates a drive command for controlling the speed, torque, or rotor position of the servomotors for drive 3, based on, e.g., the speed of the servomotors for drive 3 detected by a speed detector 51 (speed feedback), current flowing through the winding of the servomotors for drive 3 (current feedback), a predetermined torque command, and an operation program for the servomotors for drive 3. The power conversion operation by the inverters 120 in the servo-amplifiers for drive 12 is controlled in accordance with the drive command generated by the servomotor-for-drive control device 10. Note that the configuration of the servomotor-for-drive control device 10 defined herein is merely an example, and the configuration of the servomotor-for-drive control device 10 may be defined using terms such as a position command generation unit, a torque command generation unit, and a switching command generation unit.

The motor drive system 1 includes a power storage device 13 that assists the power source unit 11 to allow driving of the servomotors for drive 3 with output higher than the maximum power supply of the converter 110 in the power source unit 11 and returning power that exceeds the maximum regenerative power of the converter 110 in the power source unit 11 from the DC link 4 to the AC power source 2 side.

The power storage device 13 stores DC power from the DC link 4 (power storage) and supplies DC power to the DC link 4 (power supply). The power storage operation and power supply operation of the power storage device 13 are controlled by the power storage device control unit 15. “Base holding energy” is defined as a reference value (a target value) of energy that the power storage device 13 is supposed to store. In accordance with control by the power storage device control unit 15, the power storage device 13 stores power so that the holding energy becomes equivalent to the base holding energy as the target value. For example, when the servomotors for drive 3 are not operating and input/output of power by the power storage device 13 is not particularly required, the holding energy of the power storage device 13 is maintained at the base holding energy. When the power storage device 13 supplies power, the holding energy of the power storage device 13 decreases to a smaller value than the base holding energy; however, when the power storage device 13 stores power, the holding energy of the power storage device 13 increases and restores to the base holding energy as the target value. Note that, depending on the drive state of the servomotors for drive 3 that are driven by the motor drive system 1, the power storage device 13 may perform power supply operation before the holding energy of the power storage device 13 restores to the base holding energy.

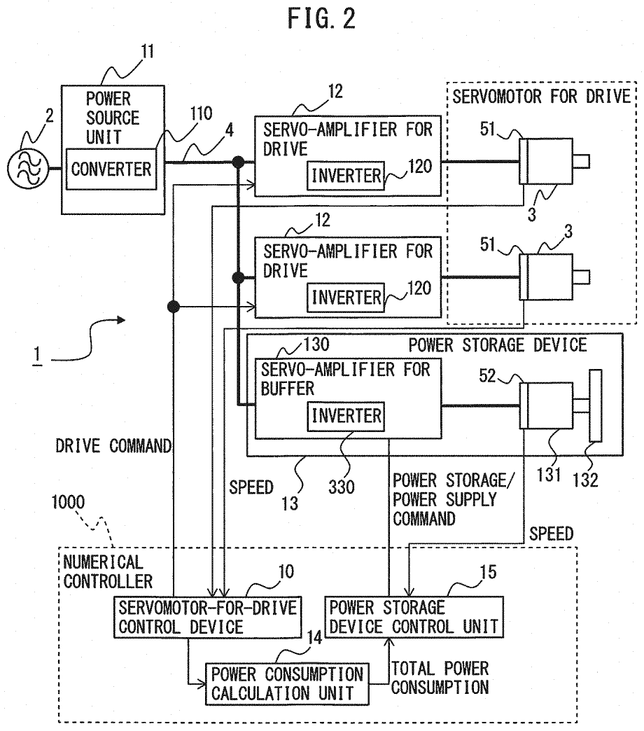

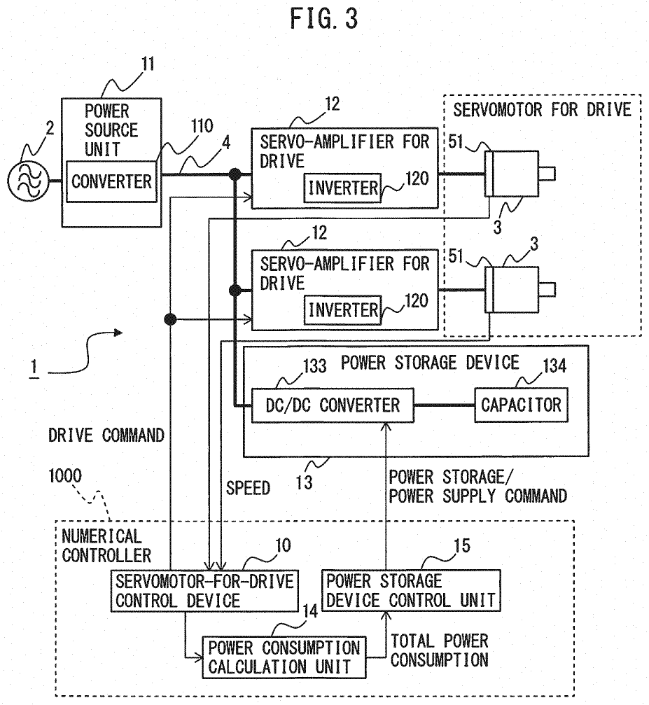

Examples of the power storage device 13 include a flywheel power storage device as illustrated in FIG. 2 and a capacitor power storage device as illustrated in FIG. 3.

FIG. 2 is a block diagram illustrating the motor drive system according to an embodiment, which includes a flywheel power storage device. The flywheel power storage device 13 includes a flywheel 132, a servomotor for buffer 131, and a servo-amplifier for buffer 130.

The flywheel 132 can store rotation energy, which is also called inertia.

The servomotor for buffer 131 is used to rotate the flywheel 132 that is connected to the rotation shaft of the servomotor for buffer 131. Rotation energy can be stored in the flywheel 132 by rotating the servomotor for buffer 131. The number of phases of the servomotor for buffer 131 does not particularly limit this embodiment, and, for example, a three-phase or single-phase AC configuration may be used. A speed detector 52 is provided in the servomotor for buffer 131, and the (rotor) speed of the servomotor for buffer 131 detected by the speed detector 52 is used to control the power storage device 13 by the power storage device control unit 15.

The servo-amplifier for buffer 130 converts power between DC power in the DC link 4 and AC power serving as drive power or regenerative power for the servomotor for buffer 131 by ON/OFF control of each switching element in accordance with a power storage or power supply command received from the power storage device control unit 15. Thus, the servo-amplifier for buffer 130 has, e.g., an inverter 330. The inverter 330 in the servo-amplifier for buffer 130 is implemented as a bridge circuit of switching elements and diodes connected in antiparallel with the switching elements. The inverter 330 is implemented as a three-phase bridge circuit when the servomotor for buffer 131 serves as a three-phase motor and as a single-phase bridge circuit when the servomotor for buffer 131 serves as a single-phase motor. Examples of the switching element may include a unipolar transistor such as an FET, a bipolar transistor, an IGBT, a thyristor, and a GTO, but the type of switching element itself does not limit this embodiment, and other types of switching element may be used. For example, ON/OFF control of each switching element equipped in the inverter 330 in the servo-amplifier for buffer 130 is performed in accordance with a PWM switching signal obtained by comparing a received drive command with a triangular carrier.

By controlling power conversion of the inverter 330 in the servo-amplifier for buffer 130 by the power storage device control unit 15, the servomotor for buffer 131 connected to the flywheel 132 rotates with acceleration or deceleration or rotates at a constant speed, so that the amount of DC power to be stored or supplied by the power storage device 13 (the amount of DC power to be input to or output from the DC link 4 by the power storage device 13) is adjusted. More specifically, the following operation is performed.

In a power storage operation of the power storage device 13, the inverter 330 in the servo-amplifier for buffer 130 performs an inversion operation for converting the DC power in the DC link 4 into AC power in accordance with a power storage command received from the power storage device control unit 15. Hence, electrical energy from the DC link 4 is fed to the servomotor for buffer 131 side and acts to rotate the servomotor for buffer 131 connected to the flywheel 132. In this manner, in the flywheel power storage device 13, electrical energy flowing from the DC link 4 is converted into rotation energy of the flywheel 132 and stored.

In a power supply operation of the power storage device 13, the inverter 330 in the servo-amplifier for buffer 130 performs a rectification operation for converting AC regenerative power into DC power by generating the AC regenerative power by decelerating the servomotor for buffer 131 connected to the flywheel 132 in accordance with a power supply command received from the power storage device control unit 15. In this manner, rotation energy stored in the flywheel 132 is converted into electrical energy and supplied to the DC link 4.

FIG. 3 is a block diagram illustrating a motor drive system according to an embodiment, which includes a capacitor power storage device. The capacitor power storage device 13 includes a capacitor 134 and a DC/DC converter 133 configured to convert power between DC power in a DC link 4 and DC power stored in the capacitor 134.

Examples of the DC/DC converter 133 include a DC/DC boost and buck chopper circuit. The amount of DC power to be stored or supplied by the power storage device 13 (the amount of DC power to be input to or output from the DC link 4 by the power storage device 13) is adjusted by controlling a boosting and bucking operation of the DC/DC converter 133 by the power storage device control unit 15. More specifically, the following operation is performed.

In a power storage operation of the power storage device 13, the DC/DC converter 133 is controlled by the power storage device control unit 15 to make DC voltage on the capacitor 134 side lower than DC voltage on the DC link 4 side in accordance with a power storage command received from the power storage device control unit 15. In this manner, electrical energy flows from the DC link 4 into the capacitor 134, and the power storage device 13 stores power.

In a power supply operation of the power storage device 13, the DC/DC converter 133 is controlled by the power storage device control unit 15 to make DC voltage on the capacitor 134 side higher than DC voltage on the DC link 4 side in accordance with a power supply command received from the power storage device control unit 15. In this manner, electrical energy flows from the capacitor 134 into the DC link 4, and the power storage device 13 supplies power.

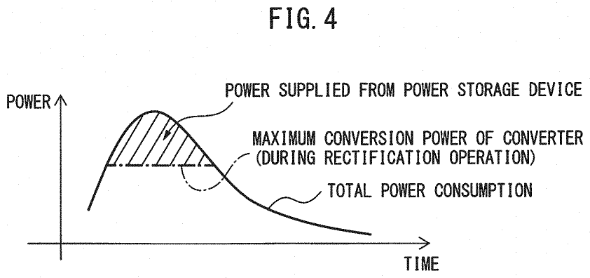

In the motor drive system 1, for example, during acceleration of the servomotors for drive 3, in addition to energy supplied from the power source unit 11, energy stored in the power storage device 13 is supplied to the servomotors for drive 3 and is used as power for accelerating the servomotors for drive 3. FIG. 4 is a graph illustrating an exemplary relationship between DC power supplied from the power storage device in the motor drive system to the DC link and DC power supplied from the power source unit to the DC link, according to an embodiment of the disclosure. Power supplied from the power source unit 11 to the DC link 4 is consumed not only as drive power for the servomotors for drive 3 (i.e., corresponding to the output of the servomotors for drive 3) but also as winding loss of the servomotors for drive 3, loss of the power source unit 11, and loss of the servo-amplifiers for drive 12. The sum of the power consumed by the servomotors for drive 3, the servo-amplifiers for drive 12 and the power source unit 11 is referred to as “total power consumption” and is indicated by a solid line in FIG. 4. An alternate long and short dashed line indicates the maximum power supply of the power supply unit 11. As illustrated in FIG. 4, the amount (a hatched area in FIG. 4) by which the maximum power supply of the power source unit 11 is exceeded in the total power consumption is compensated by DC power supplied from the power storage device 13 to the DC link 4.

In the motor drive system 1, during deceleration of the servomotors for drive 3, energy regenerated from the servomotors for drive 3 is stored in the power storage device 13. Since the energy stored in the power storage device 13 is used to drive the servomotors for drive 3 in addition to power supplied from the power source unit 11, the servomotors for drive 3 can be driven at an output higher than the maximum power supply of the power source unit 11, and power peaks can thus be reduced. In addition, even when regenerative power that exceeds the maximum regenerative power of the power source unit 11 is generated from the servomotors for drive 3, the excess power amount is stored in the power storage device 13, and power peaks can be reduced. Reducing power peaks can curb the power source capacity and the operational cost of the motor drive system 1 and can even prevent power failure and flickering of the AC power source 2 side.

Returning to FIG. 1, the power consumption calculation unit 14 calculates total power consumption as the sum of power consumed by the servomotors for drive 3 (output and winding loss of the servomotors for drive 3), power consumed by the servo-amplifiers for drive 12 (loss of the servo-amplifiers for drive 12) and power consumed by the power source unit 11 (loss of the power source unit 11). The output of the servomotors for drive 3 is obtained by multiplying the rotation speeds of the servomotors for drive 3 detected by the speed detectors 51 and the torques of the servomotors for drive 3. When the servomotors for drive 3 accelerate, they consume AC power supplied from the servo-amplifiers for drive 12, and the output of the servomotors for drive 3 upon this power consumption is defined to be “positive.” This, in turn, means that when power is regenerated upon deceleration of the servomotors for drive 3, the output of the servomotors for drive 3 is “negative.” Normally, the winding loss of the servomotors for drive 3, the loss of the power source unit 11, and the loss of the servo-amplifiers for drive 12 are lower than the absolute value of the output of the servomotors for drive 3, thus, the output of the servomotors for drive 3 has a dominant influence on the total power consumption. Accordingly, the positive or negative sign (consumption or regeneration) of the output of the servomotors for drive 3 generally corresponds to the positive or negative sign of the total power consumption. Note that, as exemplified in FIG. 1, when there are a plurality of servo-amplifiers for drive 12 and servomotors for drive 3, the power consumption calculation unit 14 calculates the sum of the output of the plurality of servomotors for drive 3, winding loss of the plurality of servomotors for drive 3, the loss of the power source unit 11, and the loss of the plurality of servo-amplifiers for drive 12, as a total power consumption.

Note that the servo-amplifier for buffer 130 as the power storage device 13 and the DC/DC converter 133 also generate loss, thus, the power consumption calculation unit 14 may calculate, as total power consumption, the sum of the loss of the servo-amplifier for buffer 130 and the DC/DC converter 133 further added to the sum of the output of the servomotors for drive 3, the winding loss of the servomotors for drive 3, the loss of the power source unit 11, and the loss of the servo-amplifiers for drive 12. Further when there are a plurality of servo-amplifiers for buffer 130 and DC/DC converters 133, the sum of the output of the servomotors for drive 3, winding loss of the servomotors for drive 3, the loss of the power source unit 11, and the loss of the servo-amplifiers for drive 12, with further added the sum of the loss of the plurality of servo-amplifiers for buffer 130 and the plurality of DC/DC converters 133, may be calculated as total power consumption.

The power storage device control unit 15, according to the total power consumption calculated by the power consumption calculation unit 14, controls power storage and power supply of the power storage device 13. In other words, the power storage device control unit 15 outputs a power supply command, to the power storage device 13, for controlling the power storage device 13 to supply DC power stored in the power storage device 13 to the DC link 4 or outputs a power storage command, to the power storage device 13, for controlling the power storage device 13 to store the DC power of the DC link 4 in the power storage device 13. The power storage device 13 performs a power supply operation upon receiving a power supply command from the power storage device control unit 15 and performs a power storage operation upon receiving a power storage command from the power storage device control unit 15. The power storage device control unit 15 controls power storage and power supply of the power storage device 13 by controlling the power conversion operation of the inverter 330 of the servo-amplifier for buffer 130 in the power storage device 13 when the power storage device 13 is implemented as the flywheel power storage device illustrated in FIG. 2, or by controlling boosting and bucking operations of the DC/DC converter 133 in the power storage device 13 when the power storage device 13 is implemented as the capacitor power storage device illustrated in FIG. 3.

In the embodiment of the present disclosure, the power storage device control unit 15 determines start and end of power storage of the power storage device 13, based on different thresholds. Further, the power storage device control unit 15 determines start and end of power supply of the power storage device 13, based on different thresholds. The detailed descriptions are as follows.

Start determination of power storage of the power storage device 13 is performed based on a comparison result between the total power consumption calculated by the power consumption calculation unit 14 and a power storage start threshold, and end determination of power storage of the power storage device 13, which is performed after starting of power storage, is performed based on a comparison result between the total power consumption calculated by the power consumption calculation unit 14 and a power storage end threshold. When regenerative power generated by deceleration, etc. of the servomotors for drive 3 exceeds the maximum regenerative power of the converter 110 in the power source unit 11, the excess power needs to be stored in the power storage device 13, thus, the power storage start threshold is set as a determination criterion for detecting timing of starting power storage of the power storage device 13. The power storage start threshold is set to a value equal to or smaller than the maximum regenerative power of the converter 110 in the power source unit 11. Likewise, the power storage end threshold value is set as a determination criterion for detecting timing of ending power storage after starting of power storage of the power storage device 13. The absolute value of the power storage end threshold is set to a smaller value than the absolute value of the power storage start threshold. In other words, the difference between power storage start threshold and power storage end threshold becomes the hysteresis width of the thresholds relating to power storage. The power storage end threshold may be set as follows: For example, a maximum amplitude of the total power consumption, which is caused by oscillation that is different from oscillation caused by operation attributable to actual control, is actually measured (hereinafter, referred to as “measured maximum amplitude of oscillation”) by actually operating the drive axis by the motor drive system 1. Then, the power storage end threshold may be set so that the absolute value of the power storage end threshold becomes smaller by the measured maximum amplitude of oscillation than the absolute value of the power storage start threshold.

The power storage device 13 is controlled to start power storage of DC power from the DC link 4. After the power storage device 13 started storing power, the power storage device control unit 15 compares the total power consumption calculated by the power consumption calculation unit 14 and the power storage end threshold, and when it is determined that the total power consumption exceeds the power storage end threshold as the result of comparison, the power storage device 13 is controlled to end storing DC power from the DC link 4. Since the absolute value of the power storage end threshold is set to a smaller value than the absolute value of the power storage start threshold, the total power consumption when the power storage device 13 ends storing power (negative value) becomes a larger value than the total power consumption when the power storage device 13 starts storing power (negative value). The timing when the power storage device 13 starts storing power corresponds to, for example, the timing when the power storage device control unit 15 starts outputting a power storage command to the power storage device 13. The timing when the power storage device 13 ends storing power corresponds to, for example, the timing when the power storage device control unit 15 ends outputting a power storage command to the power storage device 13.

Start determination of power supply of the power storage device 13 is performed based on a comparison result between the total power consumption calculated by the power consumption calculation unit 14 and a power supply start threshold, and end determination of power supply of the power storage device 13, which is performed after starting of power supply, is performed based on a comparison result between the total power consumption calculated by the power consumption calculation unit 14 and a power supply end threshold. When output of the servomotors for drive 3 increases by acceleration, etc. of the servomotors for drive 3 and exceeds the maximum power supply of the converter 110 in the power source unit 11, power needs to be supplied from the power storage device 13, thus, the power supply start threshold is set as a determination criterion for detecting timing of starting power supply of the power storage device 13. The power supply start threshold is set to a value equal to or smaller than the maximum power supply of the converter 110 in the power source unit 11. Likewise, the power supply end threshold is set as a determination criterion for detecting timing of ending power supply after starting of power supply of the power storage device 13. The absolute value of the power supply end threshold is set to a smaller value than the absolute value of the power supply start threshold. In other words, the difference between the power supply start threshold and the power supply end threshold becomes the hysteresis width of the thresholds relating to power supply. The power supply end threshold may be set as follows: For example, a maximum amplitude of the total power consumption, which is caused by oscillation that is different from oscillation caused by operation attributable to actual control, is actually measured (hereinafter, referred to as “measured maximum amplitude of oscillation”) by actually operating the drive axis by the motor drive system 1. Then, the power supply end threshold may be set so that the absolute value of the power supply end threshold becomes smaller by the measured maximum amplitude of oscillation than the absolute value of the power supply start threshold. Note that, while the power supply from the power source unit 11 changes depending on the power supply operation or power storage operation of the power storage device 13, the change does not affect the operation of the servomotors for drive 3 (i.e., not affecting the change of the total power consumption). As such, in the above-described measurement of oscillation for the purpose of setting the power supply end threshold, the power storage device 13 may either perform power supply operation/power storage operation or stop the power supply operation/power storage operation.

The power storage device control unit 15 compares the total power consumption calculated by the power consumption calculation unit 14 and the power supply start threshold, and, as the comparison result, when it is determined that the total power consumption exceeds the power supply start threshold, the power storage device control unit 15 controls the power storage device 13 to start supplying DC power to the DC link 4. After the power storage device 13 started supplying power, the power storage device control unit 15 compares the total power consumption calculated by the power consumption calculation unit 14 and the power supply end threshold, and, as the comparison result, when it is determined that the total power consumption is lower than the power supply end threshold, the power storage device control unit 15 controls the power storage device 13 to end supplying DC power to the DC link 4. Since the absolute value of the power supply end threshold is set to a smaller value than the absolute value of the power supply start threshold, the total power consumption (positive value) when the power storage device 13 ends supplying power becomes a smaller value than the total power consumption (positive value) when the power storage device 13 starts supplying power. The timing when the power storage device 13 starts supplying power corresponds to, for example, the timing when the power storage device control unit 15 starts outputting a power supply command to the power storage device 13. Furthermore, the timing when the power storage device 13 ends supplying power corresponds to, for example, the timing when the power storage device control unit 15 ends outputting a power supply command to the power storage device 13.

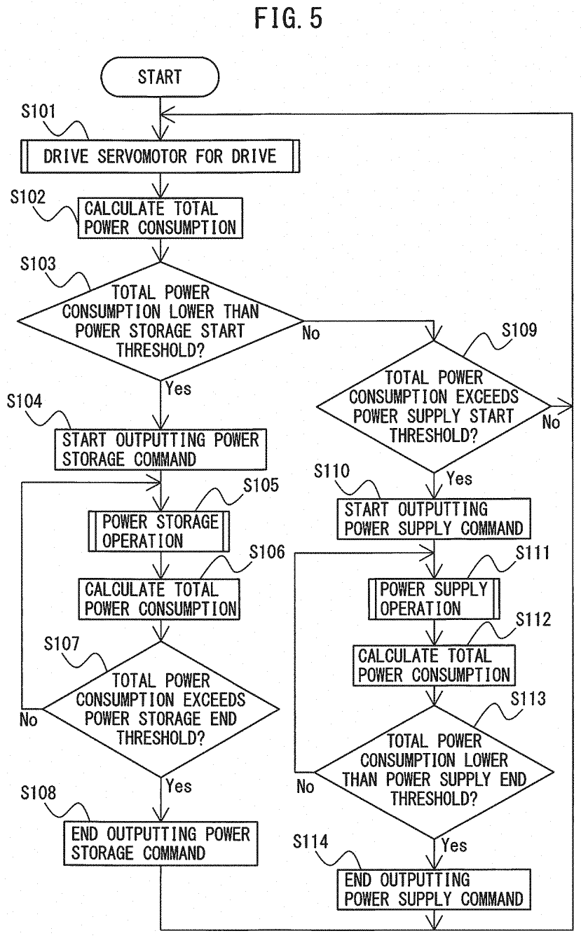

Next, the operation of the motor drive system 1 will be described. FIG. 5 is a flowchart illustrating the operation sequence of the motor drive system according to the embodiment of the disclosure.

At step S101, the servomotor-for-drive control device 10 controls the servomotors for drive 3 to operate in accordance with a predetermined operation pattern.

At step S102, the power consumption calculation unit 14 calculates total power consumption as the sum of power consumed by the servomotors for drive 3, servo-amplifiers for drive 12 and power source unit 11.

At step S103, the power storage device control unit 15 determines whether the total power consumption calculated by the power consumption calculation unit 14 is lower than the power storage start threshold. When it is determined that the total power consumption is lower than the power storage start threshold, the process advances to step S104, while, when it is not determined that the total power consumption is lower than the power storage start threshold, the process advances to step S109.

At step S104, the power storage device control unit 15 starts outputting a power storage command to the power storage device 13. As described above, “base holding energy” is defined as a reference value (a target value) that the power storage device 13 is supposed to hold, and the holding energy of the power storage device 13 is maintained at the base holding energy when the power storage device 13 performs neither storage operation nor power supply operation. When the power storage device 13 is a flywheel power storage device, at step S104 where the power storage command is started to be output, the power storage device control unit 15 outputs, to the inverter 330 in the servo-amplifier for buffer 130, a speed command (a power storage speed command) to make the speed of the servomotor for buffer 131 faster than the base speed (power storage speed), instead of a speed command (base speed command) to make the speed of the servomotor for buffer 131 base speed corresponding to the base holding energy. When the power storage device 13 is a capacitor power storage device, at step S104 where the power storage command is started to be output, the power storage device control unit 15 outputs, to the DC/DC converter 133, a voltage command (power storage voltage command) to make the voltage of the capacitor 134 higher voltage (power storage voltage) than base voltage, instead of a voltage command (base voltage command) to make the voltage of the capacitor 134 the base voltage corresponding to the base holding energy.

The power storage device 13 that received the power storage command, at step S105, stores DC power in the DC link 4. When the power storage device 13 is a flywheel power storage device, the inverter 330 in the servo-amplifier for buffer 130 converts power in accordance with a power storage speed command, by which the servomotor for buffer 131 gradually increases speed from the base speed to power storage speed. When the power storage device 13 is a capacitor power storage device, the DC/DC converter 133 converts power in accordance with a power storage voltage command, by which the capacitor 134 gradually increases voltage from the base voltage to power storage voltage. As the result, for example, power corresponding to difference between the absolute value of the total power consumption calculated by the power consumption calculation unit 14 and the maximum regenerative power as the maximum conversion power of the inversion operation of the converter 110 in the power source unit 11, is stored in the power storage device 13.

At step S106, the power consumption calculation unit 14 calculates the total power consumption as the sum of power consumed by the servomotors for drive 3, servo-amplifiers for drive 12 and power source unit 11.

At step S107, the power storage device control unit 15 determines whether the total power consumption calculated by the power consumption calculation unit 14 exceeds the power storage end threshold. When it is determined that the total power consumption exceeds the power storage end threshold, the process advances to step S108, while, when it is not determined that the total power consumption exceeds the power storage end threshold, the process returns to step S105.

At step S108, the power storage device control unit 15 ends outputting the power storage command to the power storage device 13. When the power storage device 13 is a flywheel power storage device, when outputting of the power storage command ends at step S108, the power storage device control unit 15 outputs a base speed command instead of the power storage speed command to the inverter 330 in the servo-amplifier for buffer 130. When the power storage device 13 is a capacitor power storage device, when outputting of the power storage command ends at step S108, the power storage device control unit 15 outputs a base voltage command instead of the power storage voltage command to the DC/DC converter 133. After step S108, the holding energy of the power storage device 13 is maintained at base holding energy, and the process returns to step S101.

When it is not determined that the total power consumption is lower than the power storage start threshold at step S103, at step S109, the power storage device control unit 15 determines whether the total power consumption calculated by the power consumption calculation unit 14 exceeds the power supply start threshold. When it is determined that the total power consumption exceeds the power supply start threshold, the process advances to step S110, and when it is not determined that the total power consumption exceeds the power supply start threshold, the process returns to step S101.

At step S110, the power storage device control unit 15 starts outputting a power supply command to the power storage device 13. When the power storage device 13 is a flywheel power storage device, when outputting of the power supply command starts at step S110, the power storage device control unit 15 outputs, to the inverter 330 in the servo-amplifier for buffer 130, a speed command to make the speed of the servomotor for buffer 131 lower speed (power supply speed) than the base speed (power supply speed command) instead of the base speed command. When the power storage device 13 is a capacitor power storage device, when outputting of the power supply command starts at step S110, the power storage device control unit 15 outputs, to the DC/DC converter 133, a voltage command to make the voltage of the capacitor 134 lower voltage (power supply voltage) than the base voltage (power supply voltage command) instead of the base voltage command.

The power storage device 13 that received the power supply command supplies DC power to the DC link 4 at step S111. When the power storage device 13 is a flywheel power storage device, the inverter 330 of the servo-amplifier for buffer 130 converts power in accordance with the power supply speed command, by which the servomotor for buffer 131 gradually decreases speed from the base speed to the power supply speed. When the power storage device 13 is a capacitor power storage device, the DC/DC converter 133 converts power in accordance with the power supply voltage command, by which the voltage of the capacitor 134 gradually decreases from the base voltage to the power supply voltage. As the result, for example, power corresponding to difference between (the absolute value of) the total power consumption calculated by the power consumption calculation unit 14 and the maximum power supply as the maximum conversion power of the rectification operation of the converter 110 in the power source unit 11 is supplied from the power storage device 13 to the DC link 4.

At step S112, the power consumption calculation unit 14 calculates the total power consumption as the sum of power consumed by the servomotors for drive 3, servo-amplifiers for drive 12 and power source unit 11.

At step S113, the power storage device control unit 15 determines whether the total power consumption calculated by the power consumption calculation unit 14 is lower than the power supply end threshold. When it is determined that the total power consumption is lower than the power supply end threshold, the process advances to step S114; however, when it is not determined that the total power consumption is lower than the power supply end threshold, the process returns to step S111.

At step S114, the power storage device control unit 15 ends outputting the power supply command to the power storage device 13. When the power storage device 13 is the flywheel power storage device, when outputting of the power supply command ends at step S114, the power storage device control unit 15 outputs a base speed command to the inverter 330 in the servo-amplifier for buffer 130 instead of the power supply speed command. When the power storage device 13 is the capacitor power storage device, when outputting of the power supply command ends at step S114, the power storage device control unit 15 outputs, to the DC/DC converter 133, a base voltage command instead of the power supply voltage command. After step S114, the holding energy of the power storage device 13 is maintained at the base holding energy and the process returns to step S101.

Note that the processing of step S103 and following steps S104 to S108, and the processing of step S109 and following steps S110 to S114 may be exchanged and executed.

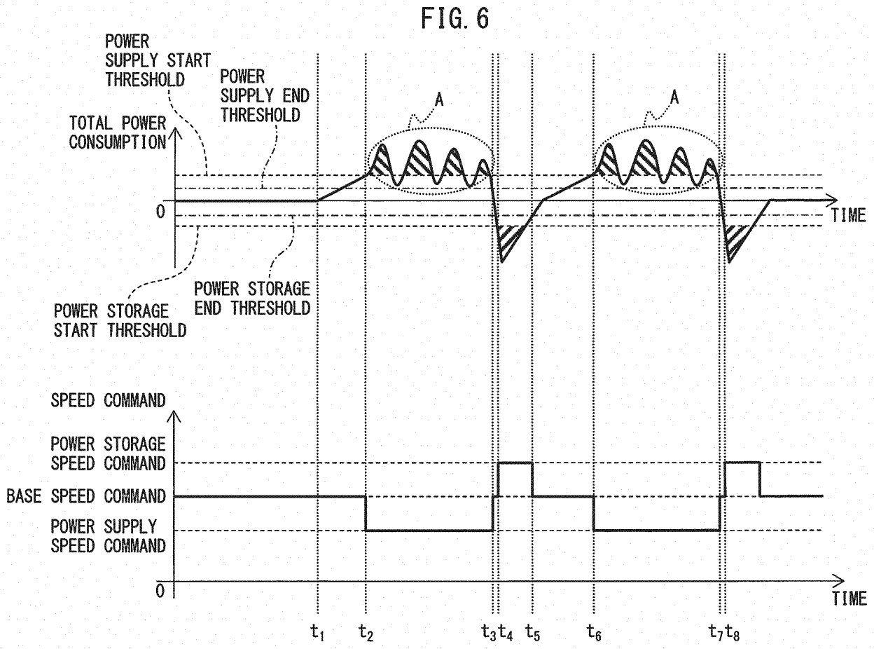

FIG. 6 is a timing chart illustrating an exemplary relationship between the total power consumption and a speed command that is output by the power storage device control unit in the motor drive system that includes the flywheel power storage device according to an embodiment of the disclosure. In FIG. 6, the upper waveform exemplifies the total power consumption [W] calculated by the power consumption calculation unit 14, dashed lines indicate the power storage start threshold and the power supply start threshold, alternate long and short dashed lines indicate the power storage end threshold and the power supply end threshold. Further, in FIG. 6, the lower waveform indicates the speed command that the power storage device control unit 15 outputs. As an example, as indicated by the upper waveform of FIG. 6, an example where the total power consumption changes with acceleration/deceleration of the servomotors for drive 3 by the motor drive system 1 is illustrated. The inverters 120 in the servo-amplifiers for drive 12 perform, according to the operational state (power running or regenerating) of the servomotors for drive 3, an inversion operation for converting DC power of the DC link 4 into AC power and outputting the AC power to the servomotor for drive 3 side or a rectification operation for converting AC power regenerated by the servomotors for drive 3 into DC power and returning the DC power to the DC link 4; however, the descriptions of the inversion operation and rectification operation of the inverters 120 are omitted from the following description. For example, “DC power of the DC link 4 is consumed by the servomotors for drive 3” means that DC power of the DC link 4 is converted into AC power by the inverters 120 in the servo-amplifiers for drive 12 and output to the servomotor for drive 3 side and consumed by the servomotors for drive 3. Further, “AC power regenerated by the servomotors for drive 3 is returned to the DC link 4” means that the AC power regenerated by the servomotors for drive 3 is converted into DC power by the inverters 120 in the servo-amplifiers for drive 12 and output to the DC link 4 side.

The servomotors for drive 3 do not operate from time 0 to timeₜ₁. When the servomotors for drive 3 start accelerating at timeₜ₁, the total power consumption calculated by the power consumption calculation unit 14 gradually increases. When the total power consumption calculated by the power consumption calculation unit 14 exceeds the power supply start threshold at timeₜ₂ (step S109), the power storage device control unit 15 outputs a power supply speed command to the inverter 330 in the servo-amplifier for buffer 130 instead of the base speed command (step S110). As the result, the servomotor for buffer 131 connected to the flywheel 132 gradually decelerates and generates AD regenerative power, and the inverter 330 in the servo-amplifier for buffer 130 performs a rectification operation for converting this AD power into DC power and outputting the DC power to the DC link 4. In this way, the rotation energy stored in the flywheel 132 is converted into electric energy and supplied to the DC link 4 (step S111). As described above, since the power supply end threshold is set so that the absolute value of the power supply end threshold becomes smaller than the absolute value of the power supply start threshold by the maximum amplitude of oscillation that has been previously measured, the power supply operation of the flywheel power storage device 13 is maintained even when there is oscillation in the total power consumption that is different from oscillation caused by operation attributable to actual control (indicated by A in FIG. 6). When the total power consumption decreases due to decreases in torque and speed of the servomotors for drive 3, and, accordingly, the total power consumption becomes lower than the power supply end threshold at timeₜ₃ (step S113), the power storage device control unit 15 outputs a base speed command to the inverter 330 in the servo-amplifier for buffer 130 instead of the power supply speed command (step S114). As the result, the servomotor for buffer 131 connected to the flywheel 132 gradually accelerates toward the base speed. When the total power consumption further decreases and the total power consumption becomes lower than the power storage start threshold at timeₜ₄ (step S103), the power storage device control unit 15 outputs a power storage speed command to the inverter 330 in the servo-amplifier for buffer 130 instead of the base speed command (step S104). As the result, the servomotor for buffer 131 increases speed to the power storage speed. In this way, the DC power in the DC link 4 is converted into AC power by the inverter 330 in the servo-amplifier for buffer 130, this AC power rotates the servomotor for buffer 131, and the rotation energy is stored in the flywheel 132 (step S105). After timeₜ₄, when the servomotors for drive 3 start accelerating again, the total power consumption calculated by the power consumption calculation unit 14 gradually increases. When the total power consumption calculated by the power consumption calculation unit 14 exceeds the power storage end threshold at timeₜ₅ (step S107), the power storage device control unit 15 outputs a base speed command to the inverter 330 in the servo-amplifier for buffer 130 instead of the power storage speed command (step S108). At timeₜ₅ and later, according to the total power consumption calculated by the power consumption calculation unit 14, the power storage device control unit 15 controls power storage and power supply of the flywheel power storage device 13.

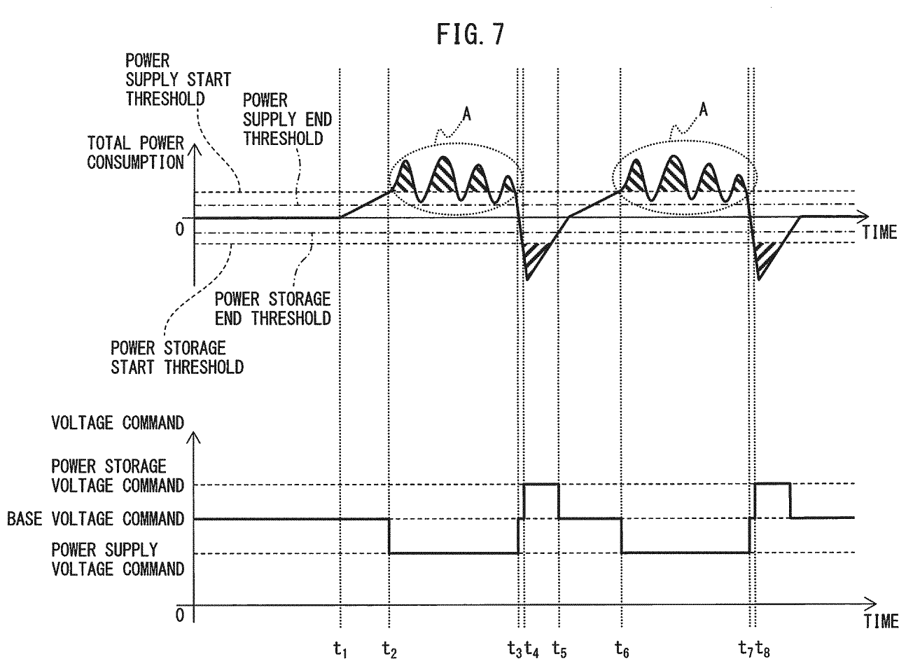

FIG. 7 is a timing chart illustrating an exemplary relationship between the total power consumption and a voltage command that is output by the power storage device control unit in the motor drive system that includes the capacitor power storage device according to an embodiment of the disclosure. In FIG. 7, the upper waveform exemplifies total power consumption [W] calculated by the power consumption calculation unit 14, dashed lines indicate the power storage start threshold and the power supply start threshold, and alternate long and short dashed lines indicate the power storage end threshold and the power supply end threshold. Further, in FIG. 7, the lower waveform indicates a voltage command that is output by the power storage device control unit 15. As an example, as indicated by the upper waveform of FIG. 7, an example where the total power consumption changes with acceleration/deceleration of the servomotors for drive 3 by the motor drive system 1 is illustrated. The inverters 120 in the servo-amplifiers for drive 12 perform, according to the operational state of the servomotors for drive 3 (power running or regenerating), an inversion operation for converting DC power of the DC link 4 into AC power and outputting the AC power to the servomotor for drive 3 side or a rectification operation for converting AC power regenerated by the servomotors for drive 3 into DC power and returning the DC power to the DC link 4; however, as in the case of FIG. 6, the descriptions of the inversion operation and rectification operation of the inverters 120 are omitted in the following description.

The servomotors for drive 3 do not operate from time 0 to timeₜ₁. When the servomotors for drive 3 start accelerating at timeₜ₁, the total power consumption calculated by the power consumption calculation unit 14 gradually increases. When total power consumption calculated by the power consumption calculation unit 14 exceeds the power supply start threshold at timeₜ₂ (step S109), the power storage device control unit 15 outputs a power supply voltage command instead of a base voltage command to the DC/DC converter 133 (step S110). As the result, the voltage of the capacitor 134 connected to the DC/DC converter 133 gradually decreases and DC power is supplied to the DC link 4 (step S111). As described above, since the power supply end threshold is set so that the absolute value of the power supply end threshold becomes smaller than the absolute value of the power supply start threshold by the maximum amplitude of oscillation that has been previously measured, the power supply operation of the capacitor power storage device 13 is maintained even when there is oscillation in the total power consumption that is different from oscillation caused by operation attributable to actual control (indicated by A in FIG. 7). When the total power consumption decreases due to decreases in torque and speed of the servomotors for drive 3 and, accordingly, the total power consumption becomes lower than the power supply end threshold at timeₜ₃ (step S113), the power storage device control unit 15 outputs a base voltage command instead of the power supply voltage command to the DC/DC converter 133 (step S114) As the result, the voltage of the capacitor 134 connected to the DC/DC converter 133 gradually increases toward the base voltage. When the total power consumption further decreases and the total power consumption becomes lower than the power storage start threshold at timeₜ₄ (step S103), the power storage device control unit 15 outputs a power storage voltage command to the DC/DC converter 133 instead of the base voltage command (step S104). As the result, the voltage of the capacitor 134 gradually increases toward the power storage voltage. In this way, the DC power in the DC link 4 is stored in the capacitor 134 through the DC/DC converter 133 (step S105). After timeₜ₄, when the servomotors for drive 3 start accelerating again, the total power consumption calculated by the power consumption calculation unit 14 gradually increases. When the total power consumption calculated by the power consumption calculation unit 14 exceeds the power storage end threshold at timeₜ₅, (step S107), the power storage device control unit 15 outputs a base voltage command to the DC/DC converter 133 instead of the power storage voltage command (step S108). At timeₜ₅ and later, according to the total power consumption calculated by the power consumption calculation unit 14, the power storage device control unit 15 controls power storage and power supply of the capacitor power storage device 13.

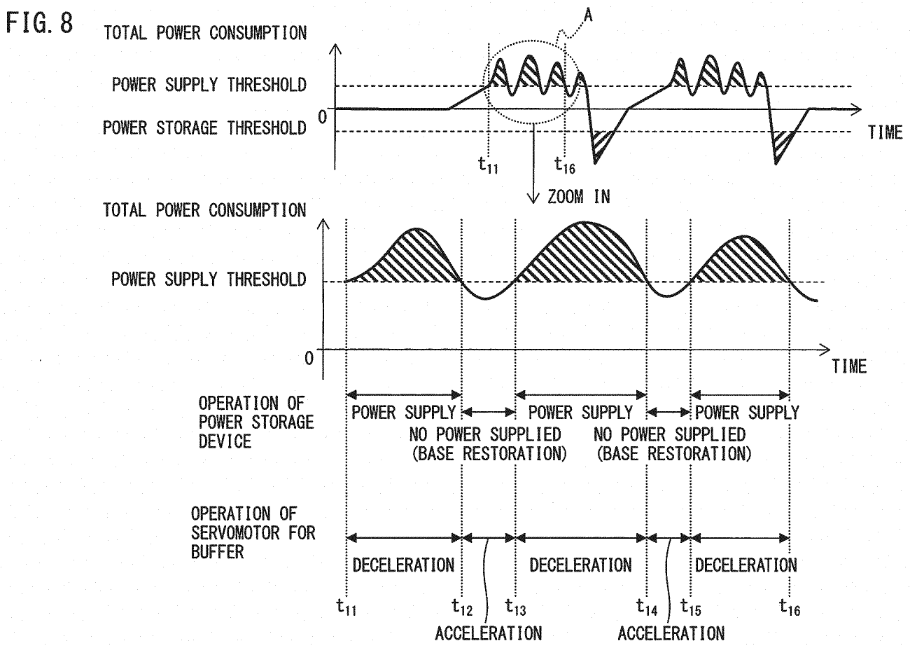

FIG. 8 is a timing chart illustrating an exemplary relationship between the total power consumption and a speed command that is output by the power storage device control unit in a conventional motor drive system where power storage start and power storage end of the flywheel power storage device are detected with the same power storage threshold and power supply start and power supply end of the power storage device are detected with the same power supply threshold. In FIG. 8, the upper waveform exemplifies total power consumption [W] as the sum of power consumed by the servomotor for drive, servo-amplifier for drive and power source unit, and dashed lines indicate a power storage threshold and a power supply threshold. Further, in FIG. 8, the lower waveform is an enlarged view of the oscillation of the total power consumption that is different from oscillation caused by operation attributable to actual control, indicated by A in the upper waveform (from timeₜ₁₁ to timeₜ₁₆). As an example, as indicated by the upper waveform of FIG. 8, an example where the total power consumption changes with acceleration/deceleration of the servomotor for drive by the motor drive system is illustrated, though the behavior of the total power consumption is the same as the upper waveforms in FIGS. 6 and 7. In the conventional motor drive system, when the total power consumption gradually increases from a state where the total power consumption is larger than the power storage threshold and smaller than the power supply threshold to a state where the total power consumption exceeds the power supply threshold, the power storage device starts supplying DC power to the DC link, and after starting the power supply operation, when the total power consumption value becomes lower than the power supply threshold, the power storage device ends supplying DC power to the DC link (base restoration). Further, when the total power consumption gradually decreases from a state where the total power consumption is larger than the power storage threshold and smaller than the power supply threshold to a state where the total power consumption is lower than the power storage threshold, the power storage device starts a power storage operation so that the holding energy becomes the base holding energy, and after starting the power storage operation, when the total power consumption value exceeds the power storage threshold, the power storage device ends the power storage operation (base restoration).

When the servomotor for drive starts accelerating, the total power consumption gradually increases, and, when the total power consumption exceeds the power supply start threshold at timeₜ₁₁, the power storage device control unit outputs a power supply command to the flywheel power storage device. The servomotor for buffer connected to the flywheel gradually decelerates (power supply operation of the power storage device). When the total power consumption becomes lower than the power supply threshold at timeₜ₁₂ due to the oscillation of the total power consumption that is different from oscillation caused by operation attributable to actual control, the power storage device control unit outputs a based command to the power storage device instead of the power supply command, and, as the result, the servomotor for buffer gradually accelerates so that the holding energy of the power storage device restores to the base holding energy (base restoration). Likewise, when the total power consumption exceeds the power supply threshold at timeₜ₁₃ due to the oscillation of the total power consumption, the power storage device control unit outputs a power supply command to the power storage device instead of the base command, and the servomotor for buffer connected to the flywheel decelerates again (power supply operation). In this way, when the total power consumption exceeds the power supply threshold due to oscillation of the total power consumption that is different from oscillation caused by operation attributable to actual control, the servomotor for buffer decelerates, while, when the total power consumption becomes lower than the power supply threshold, the servomotor for buffer accelerates. In other words, due to oscillation of the total power consumption that is different from oscillation caused by operation attributable to actual control, the servomotor for buffer connected to the flywheel frequently accelerates and decelerates. As the result, the servomotor for buffer suffers heavy burden and becomes susceptible to failure and shortening of life. In addition, the same phenomenon occurs in the case of, e.g., a capacitor power storage device.

On the other hand, according to the embodiment of the present disclosure, the power storage device control unit 15 determines start and end of power storage of the power storage device 13, based on different thresholds (i.e., the power storage start threshold and the power storage end threshold) and determines start and end of power supply of the power storage device 13, based on different thresholds (i.e., the power supply start threshold and the power supply end threshold), thus, as described with reference to FIGS. 6 and 7, the power supply operation of the power storage device 13 is maintained even when there is oscillation in the total power consumption that is different from oscillation caused by operation attributable to actual control. Therefore, little burden is applied to the servomotor for buffer 131 of the flywheel power storage device 13 or the capacitor 134 of the capacitor power storage device 13, avoiding failure and extending the life of the power storage device 13.

The above-described power consumption calculation unit 14, the power storage device control unit 15 and the servomotor-for-drive control device 10 may be implemented as, e.g., a software program; alternatively, these units may be implemented as a combination of a variety of electrical circuits and a software program. For example, when these units are implemented as a software program, the functions of the above-described units can be realized when the processor in the motor drive system 1 operates in accordance with this software program. Alternatively, the power consumption calculation unit 14, the power storage device control unit 15 and the servomotor-for-drive control device 10 may be realized as a semiconductor circuit on which a software program that realizes the functions of the units is written.

According to the embodiment of the disclosure, the motor drive system including a power storage device that is provided for decreasing power peaks of power supply equipment can avoid failure and extend the life of the power storage device.

1. A motor drive system comprising:
a power source unit configured to supply DC power to a DC link;
a servo-amplifier for drive configured to convert the DC power in the DC link into AC power and supply the AC power as drive power to a servomotor for drive;
a power storage device configured to store the DC power from the DC link or supply the DC power to the DC link;
a power consumption calculation unit configured to calculate total power consumption as the sum of power consumed by the servomotor for drive, the servo-amplifier for drive and the power source unit; and
a power storage device control unit configured to control power storage and power supply of the power storage device according to the total power consumption,
wherein the power storage device control unit determines start and end of power storage or power supply of the power storage device, based on different thresholds.

2. The motor drive system according to claim 1, wherein
the power storage device control unit compares the total power consumption and a preset power storage start threshold, and as a comparison result, when it is determined that the total power consumption is lower than the power storage start threshold, the power storage device control unit controls the power storage device to start storing DC power from the DC link, and
after the power storage device starting power storage, the power storage device control unit compares the total power consumption and a preset power storage end threshold, and as a comparison result, when it is determined that the total power consumption exceeds the power storage end threshold, the power storage device control unit controls the power storage device to end storing DC power from the DC link.

3. The motor drive system according to claim 2, wherein
the absolute value of the power storage end threshold is smaller than the absolute value of the power storage start threshold.

4. The motor drive system according to claim 1, wherein
the power storage device control unit compares the total power consumption and a preset power supply start threshold, and as a comparison result, when it is determined that the total power consumption exceeds the power supply start threshold, the power storage device control unit controls the power storage device to start supplying DC power to the DC link, and
after the power storage device starting power supply, the power storage device control unit compares the total power consumption and a preset power supply end threshold, and as a comparison result, when it is determined that the total power consumption is lower than the power supply end threshold, the power storage device control unit controls the power storage device to end supplying DC power to the DC link.

5. The motor drive system according to claim 4, wherein the absolute value of the power supply end threshold is smaller than the absolute value of the power supply start threshold.

6. The motor drive system according to claim 1, wherein the power source unit is a converter configured to convert AC power supplied to from the AC power source into DC power and output the DC power to the DC link.

7. The motor drive system according to claim 1, wherein the power storage device comprises:
a flywheel configured to store rotation energy;
a servomotor for buffer comprising a rotation shaft coupled to the flywheel; and
a servo-amplifier for buffer configured to convert power between DC power in the DC link and AC power as drive power or regenerative power for the servomotor for buffer.

8. The motor drive system according to claim 1, wherein the power storage device comprises a capacitor.
